(19) United States
(12) Patent Application Publication
(10) Pub. No.: US 2024/0004779 A1
(43) Pub. Date: Jan. 4, 2024

(54) FRAMEWORK FOR DISTRIBUTED OPEN-LOOP VEHICLE SIMULATION

(71) Applicant: EMBARK TRUCKS, INC., San Francisco, CA (US)

(72) Inventors: Liam BENSON, San Francisco, CA (US); Konstantine MUSHEGIAN, San Franscico, CA (US)

(21) Appl. No.: 17/853,326

(22) Filed: Jun. 29, 2022

(51) Int. Cl. G06F 11/36

(52) U.S. Cl. CPC G06F 11/3624; G06F 11/3688; G06F 11/3684

(57) ABSTRACT

Provided is a system and method that provides an open-loop simulation system for testing self-driving software for autonomous vehicles. As self-driving code is updated, a developer may test the self-driving code against previously-captured driving data captured while on the road. In one example, the method may include receiving a request to simulate self-driving code against previously-captured driving data via a host platform, dividing the driving data into a plurality of data chunks, compressing the self-driving code to create compressed self-driving code, generating a plurality of simulation tasks for testing the self-driving code based on the plurality of driving data chunks, respectively, executing the plurality of simulation tasks in parallel via a plurality of workers of the host platform, respectively, and storing execution results of the plurality of simulation tasks via a memory.

### BACKGROUND

Autonomous vehicles require large-scale development and testing before they can be deployed. However, for developers, driving the necessary number of miles in the real-world to perform such development and testing can be very time consuming. Recently, developers have turned to driving simulation software to test and develop code for self-driving vehicles. As an example, the driving simulation software can be used to test a piece of code while reducing the need for real world driving. However, there are still drawbacks with this process. Most notably, the amount of time that it takes to “simulate” the vehicle's movements on the road is equal to the amount of driving time within the data being simulated. For example, ten hours of driving data takes ten hours to simulate.

### SUMMARY

The example embodiments are directed to a open-loop simulation system in which vehicles on the road upload their driving data to a host platform, such as a cloud platform, a web server, a blockchain network, or the like. The driving data may include physical sensor data captured during a single run of a vehicle (or multiple runs) as well as planning decisions and intermediate calculations made by the vehicle when making such decisions. Furthermore, the users of the system can request to use previously uploaded driving data to test new self-driving code. In one example, a vehicle may capture driving and store it to a host platform. When a software update is ready for the vehicle, the developer may request that driving data from that vehicle (or another vehicle) be used to test the software update via a vehicle simulation system.

However, rather than run the code and the driving data as part of one large task, the example embodiments break-up the driving data into smaller data chunks. In some cases, the data chunks may be mutually exclusive segments of driving data that are not overlapping in time. For example, as driving data is uploaded to the host platform, the host may organize the data automatically into these smaller data chunks. As one example, the host may organize each data chunk into its own respective file (or files) such as a bag file (.bag), or the like, into chunks of files. In other words, the original file may be divided into smaller chunks (smaller files) for more efficient execution. Furthermore, the code may be compressed based on specifics of the simulation task that can be analyzed by the host. The data may be labeled within a data store where it is held. Furthermore, users of the system may search through the data based on the labels and request simulation from any of the accessible data.

When a new piece of code is to be tested for a vehicle, the developer may send a request to the host platform which identifies the code and data (or a previous run) of a vehicle to be used to simulate the vehicle and test the code against the simulation. In response, the host may divide the data from the previous run into many smaller-sized data chunks. As a non-limiting example, the developer may request five (5) hours of driving data be used to test the new code. Here, the host may break-up the five hours of data into smaller ten-second chunks of driving data. For example, the host may break up the five hours (18000 seconds) of driving data into 1800 chunks of driving data at ten (10) seconds each, etc. Furthermore, the host can spawn the same number of workers/threads for performing the simulations (e.g., 1800 workers) and execute the simulation of the 1800 chunks of driving data at the same time (in parallel) which reduces the overall simulation time from five hours to ten seconds.

According to an aspect of an example embodiment, provided is an apparatus that may include a network interface configured to receive a request to simulate self-driving code against previously-captured driving data via a host platform, and a processor configured to divide the driving data into a plurality of data chunks, generate a plurality of simulation tasks for testing the self-driving code based on the plurality of driving data chunks, respectively, execute the plurality of simulation tasks in parallel via a plurality of workers of the host platform, respectively, and store execution results of the plurality of simulation tasks via a data store.

According to an aspect of another example embodiment, provided is a method that may include receiving a request to simulate self-driving code against previously-captured driving data via a host platform, dividing the driving data into a plurality of data chunks, generating a plurality of simulation tasks for testing the self-driving code based on the plurality of driving data chunks, respectively, executing the plurality of simulation tasks in parallel via a plurality of workers of the host platform, respectively, and storing execution results of the plurality of simulation tasks via a data store.

According to an aspect of another example embodiment, provided is a non-transitory computer-readable medium with instructions which when executed by a processor cause a computer to perform a method that may include receiving a request to simulate self-driving code against previously-captured driving data via a host platform, dividing the driving data into a plurality of data chunks, generating a plurality of simulation tasks for testing the self-driving code based on the plurality of driving data chunks, respectively, executing the plurality of simulation tasks in parallel via a plurality of workers of the host platform, respectively, and storing execution results of the plurality of simulation tasks via a data store.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a control system that may be deployed in a vehicle such as the semi-truck depicted in FIGS. 2A-2C, in accordance with an example embodiment.

FIGS. 2A-2C are diagrams illustrating exterior views of a semi-truck that may be used in accordance with example embodiments.

FIGS. 3A-3D are diagrams illustrating a process of testing self-driving code in a distributed open-loop system in accordance with example embodiments.

FIGS. 4A-4B are diagrams illustrating examples of files that may be created from driving data accordance with example embodiments.

FIG. 5 is a diagram illustrating an example of a user interface for testing self-driving code in accordance with example embodiments.

FIG. 6 is a diagram illustrating a method for testing self-driving code in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The example embodiments are directed to a simulation system that can be used to test self-driving code using driving data previously uploaded from the road. The system can be hosted on a central platform such as a cloud platform, a web server, a blockchain network, or the like. In some embodiments, the system may be an open-loop system in which sensor data from the vehicle (or another vehicle) is used to test and verify control functions or the like which are performed by the self-driving code.

The driving data used during the simulation process may be driving data from the road that is previously captured by the same vehicle that is being tested or by or one or more other/different vehicles. Here, a developer may specify a new code segment (self-driving code) to be tested and a trip of driving data (single run) that the developer wants to test the self-driving code against. For example, a unique identifier may be mapped to each run that is stored by the host system.

In response, the host platform may divide the requested driving data into many small-sized segments of data based on driving time of the driving data. For example, driving data segments of predetermined intervals (e.g., 10 second intervals, or the like) may be sliced off of the driving data and added as a task to a queue at the host platform. A cloud service or other control program may spawn the same number of worker threads (workers) as there are data segments, and simultaneously execute/simulate the same piece of self-driving code based on the plurality of driving data segments at the same time.

For convenience and ease of exposition, a number of terms may be used herein. For example, the term “vehicle” may be used to refer to different types of vehicles in which systems of the example embodiments may be used. For example, a vehicle may refer to an autonomous vehicle such as a car, a truck, a semi-truck, a tractor, a boat or other floating apparatus such as a ship, a submersible, and the like.

Light detection and ranging (lidar) sensors are used by vehicles to measure a surrounding area by obtaining a sparse point cloud using distances to points in the point cloud that are measured by light beams from the lidar sensors. The illumination works independently from ambient light and can be used in any conditions. Furthermore, the lidar sensors can capture data that can be used to generate a map of the world in three-dimensions (3D). Meanwhile, vehicle cameras can capture images (e.g., RGB images, black and white images, etc.) of the world around the vehicle and provide complimentary data to the lidar data captured by the lidar sensors. For example, cameras can capture data such as color, texture, appearance, etc., while lidar is able to capture and model structural aspects of the data.

In many vehicles, the perception of the vehicle is created based on a combination (i.e., jointly) of lidar data from the lidar sensors and image data captured by the cameras. For accurate perception, these two systems must be aligned with respect to each other. Calibration can be performed to align a coordinate frame of a lidar sensor(s) with a coordinate frame of a camera by changing extrinsic parameters such as rotation and translation between the coordinate frames of the lidar sensor and the camera. These extrinsic parameters can be used to fuse information together from the lidar sensors and the image sensors when visualizing the vehicle interprets visual data from the road.

With the calibrated sensors, the vehicle can capture images and lidar readings of the area surrounding the vehicle and build/modify a three-dimensional map that is stored internally within a computer of the vehicle (or remotely via a web server). The vehicle can localize itself within the map and make decisions on how to steer, turn, slow down, etc. based on other objects, lane lines, entrance lanes, exit lanes, etc. within the map. Autonomous vehicles may use one or more computer systems to control the vehicle to move autonomously without user input. For example, the vehicle may be equipped with an autonomous vehicle (AV) system that generates signals for controlling the engine, the steering wheel, the brakes, and the like, based on other objects, lane lines, entrance lanes, and exit lanes, within the map.

In the example embodiments, a network of vehicles may be connected to a shared host platform, such as a cloud platform, a web server, or the like. The vehicles may use hardware sensor, for example, lidar, cameras, radar, and the like, to sense the world around them while they are driving. In addition, the vehicles may store decisions made by an autonomous vehicle (AV) system such as a planner, as well as intermediate calculations made by the planner, when making control decisions for the vehicle. This information may be uploaded to the host platform and labeled with a particular ID. For example, a driving data from a ten-hour trip/run may be labeled with an identifier of the trip, an identifier of the vehicle that performed the trip, and the like.

Furthermore, users can also access/connect to the shared host platform via a user interface, or the like. Here, the users can request a piece of self-driving code be tested based on previously-captured driving data from one or more of the vehicles that have uploaded data to the shared host platform, including the same vehicle where the self-driving code is being tested. The user may also specify a run/trip of driving data (for example by providing the ID of the run, etc.) to be used for testing the self-driving code. In response, the host may break-up the testing into a plurality of simulation tasks where each simulation task simulates a different small segment of driving data from the run/trip. By breaking up the simulation into many small simulations, the simulations can be run in parallel via a plurality of workers on the host platform. As a result, the testing of the self-driving code may be reduced from ten hours of time to a few seconds of time.

In some of the examples herein, the vehicle is illustrated as a semi-truck. However, it should be appreciated that the example embodiments are applicable to any kind of autonomous vehicle and not just trucks or semi-trucks but instead may include cars, boats, tractors, motorcycles, and the like, as well as trucks of all kinds. Furthermore, in the examples herein, terms like “minimum”, “maximum”, “safe”, “conservative”, and the like, may be used. These terms should not be construed as limiting any type of distance or speed in any way.

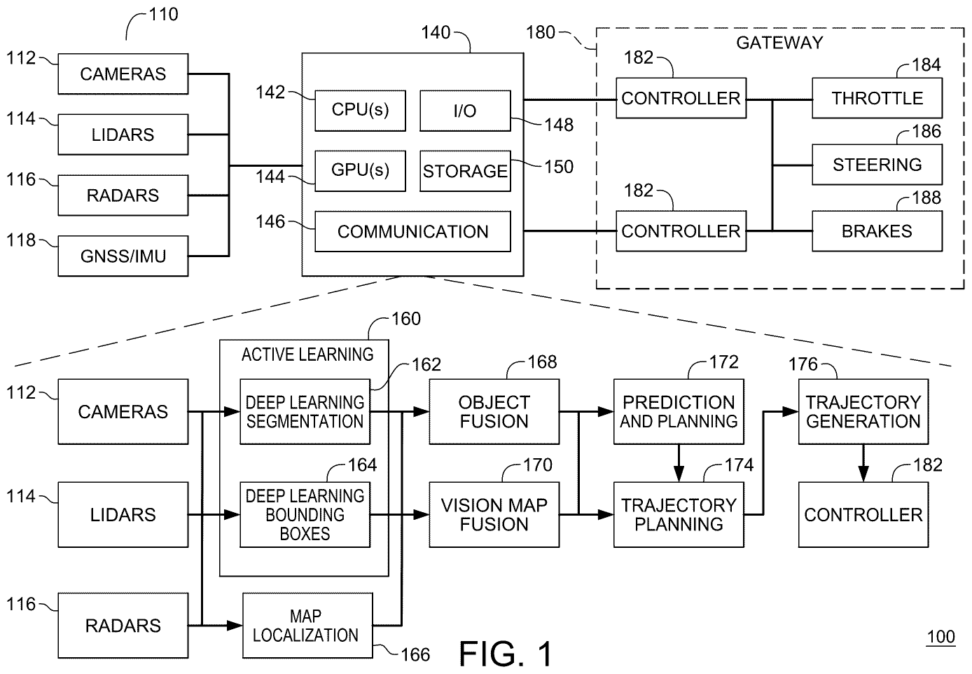

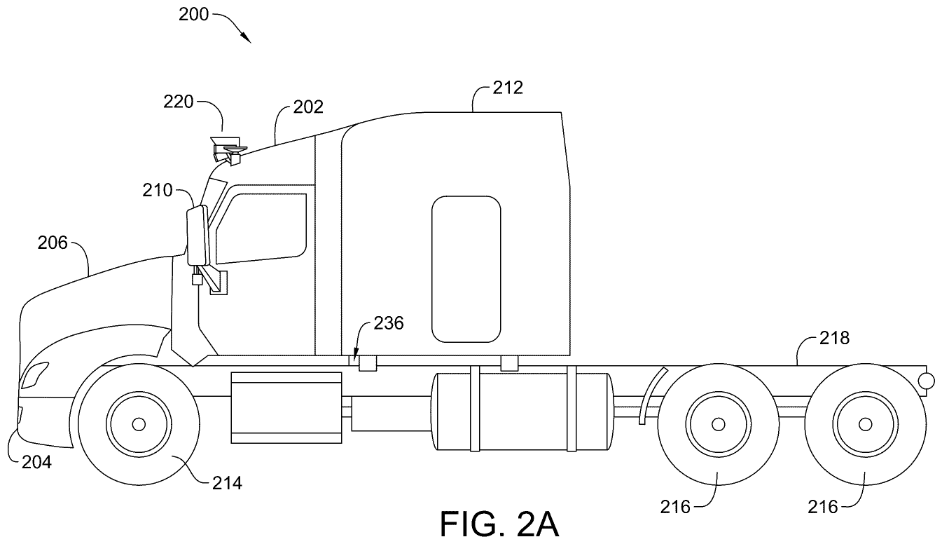

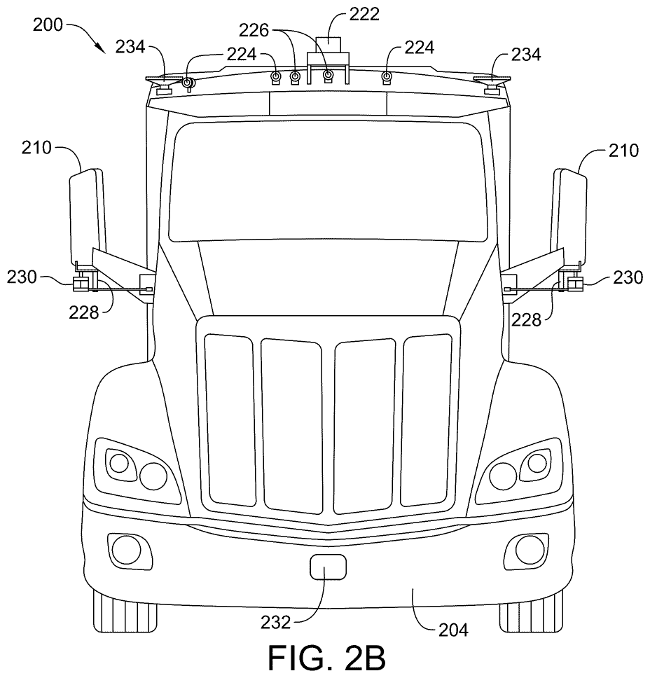

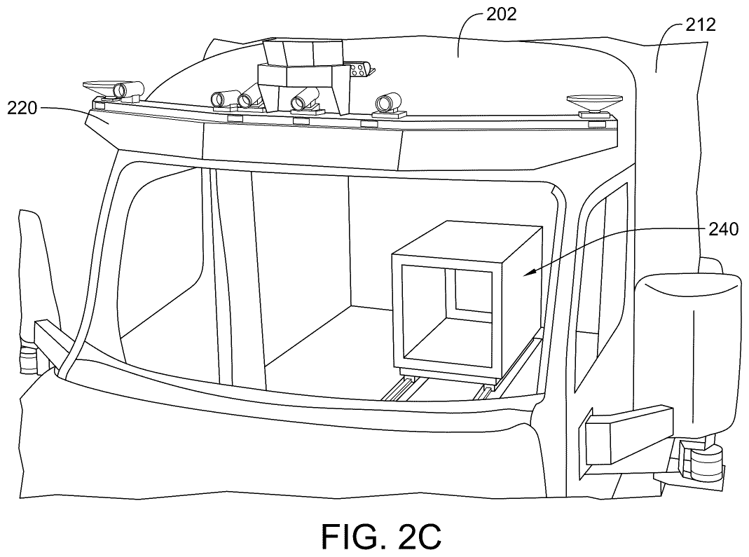

FIG. 1 illustrates a control system 100 that may be deployed in a vehicle such as the semi-truck 200 depicted in FIGS. 2A-2C, in accordance with an example embodiment. In some embodiments, the vehicle may be referred to as an ego vehicle. Referring to FIG. 1, the control system 100 may include a number of sensors 110 which collect data and information provided to a computer system 140 to perform operations including, for example, control operations which control components of the vehicle via a gateway 180. Pursuant to some embodiments, the gateway 180 is configured to allow the computer system 140 to control a number of different components from different manufacturers.

The computer system 140 may be configured with one or more central processing units (CPUs) 142 to perform processing including processing to implement features of embodiments of the present invention as described elsewhere herein as well as to receive sensor data from sensors 110 for use in generating control signals to control one or more actuators or other controllers associated with systems of the vehicle (including, for example, actuators or controllers allowing control of a throttle 184, steering systems 186, brakes 188 or the like). In general, the control system 100 may be configured to operate the semi-truck 00 in an autonomous (or semi-autonomous) mode of operation.

In operation, the control system 100 may be operated to capture images from one or more cameras 112 mounted on various locations of the semi-truck 200 and perform processing (such as image processing) on those images to identify objects proximate or in a path of the semi-truck 200. Further, lidar 114 and radar 116 sensors may be positioned to sense or detect the presence and volume of objects proximate or in the path of the semi-truck 200. Other sensors may also be positioned or mounted on various locations of the semi-truck 200 to capture other information such as position data. For example, the sensors may include one or more satellite positioning sensors and/or inertial navigation systems such as GNSS/IMU 118. A Global Navigation Satellite System (GNSS) is a space-based system of satellites that provide the location information (longitude, latitude, altitude) and time information in all weather conditions, anywhere on or near the Earth to devices called GNSS receivers. GPS is the world's most used GNSS system. An inertial measurement unit (“IMU”) is an inertial navigation system. In general, an inertial navigation system (“INS”) measures and integrates orientation, position, velocities, and accelerations of a moving object. An INS integrates the measured data, where a GNSS is used as a correction to the integration error of the INS orientation calculation. Any number of different types of GNSS/IMU 118 sensors may be used in conjunction with features of the present invention. The data collected by each of these sensors may be processed by the computer system 140 to generate control signals that control the operation of the semi-truck 200. The images and location information may be processed to identify or detect objects around or in the path of the semi-truck 200 and control signals may be emitted to adjust the throttle 184, steering 186 or brakes 188 as needed to safely operate the semi-truck 200. While illustrative example sensors and actuators or vehicle systems are shown in FIG. 1, those skilled in the art, upon reading the present disclosure, will appreciate that other sensors, actuators or systems may also be used. For example, in some embodiments, actuators to allow control of the transmission of the semi-truck 200 may also be provided.

The control system 100 may include a computer system 140 (such as a computer server) which is configured to provide a computing environment in which one or more software or control applications (such as items 160-182) may be executed to perform the processing described herein. In some embodiments, the computer system 140 includes components which are deployed on a semi-truck 200 (e.g., they may be deployed in a systems rack 240 positioned within a sleeper compartment 212 as shown in FIG. 2C). The computer system 140 may be in communication with other computer systems (not shown) that may be remote from the semi-truck 200 (e.g., the computer systems may be in communication via a network connection).

In some examples, the computer system 140 may be implemented as a server. Furthermore, the computer system 140 may configured using any of a number of well-known computing systems, environments, and/or configurations such as, but not limited to, personal computer systems, cloud platforms, server computer systems, thin clients, thick clients, hand-held or laptop devices, tablets, smart phones, databases, multiprocessor systems, microprocessor-based systems, set top boxes, programmable consumer electronics, network PCs, minicomputer systems, mainframe computer systems, distributed cloud computing environments, and the like, which may include any of the above systems or devices, and the like.

A number of different software applications or components may be executed by the computer system 140 and the control system 100. For example, as shown, applications may be provided which perform active learning machine processing (active learning component 160) to process images captured by one or more cameras 112 and information obtained by lidar 114. For example, image data may be processed using deep learning segmentation models 162 to identify objects of interest in those images (such as, for example, other vehicles, construction signs, etc.). Lidar data may be processed by the machine learning applications 164 to draw or identify bounding boxes on image data to identify objects of interest located by the lidar sensors. Information output from the machine learning applications may be provided as inputs to object fusion 168 and vision map fusion 170 software components which may perform processing to predict the actions of other road users and to fuse local vehicle poses with global map geometry in real-time, enabling on-the-fly map corrections. The outputs from the machine learning applications may be supplemented with information from radars 116 and map localization 166 application data (as well as with positioning data). These applications allow the control system 100 to be less map reliant and more capable of handling a constantly changing road environment. Further, by correcting any map errors on the fly, the control system 100 can facilitate safer, more scalable and more efficient operations as compared to alternative map-centric approaches. Information is provided to prediction and planning application 172 which provides input to trajectory planning 174 components allowing a trajectory 176 to be generated in real time based on interactions and predicted interactions between the semi-truck 200 and other relevant vehicles in the environment. In some embodiments, for example, the control system 100 generates a sixty second planning horizon, analyzing relevant actors and available trajectories. The plan that best fits multiple criteria (including safety, comfort and route preferences) is selected and any relevant control inputs needed to implement the plan are provided to controllers 182 to control the movement of the semi-truck 200.

These applications or components (as well as other components or flows described herein) may be implemented in hardware, in a computer program executed by a processor, in firmware, or in a combination of the above. A computer program may be embodied on a computer readable medium, such as a storage medium or storage device. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

A storage medium may be coupled to the processor such that the processor may read information from, and write information to, the storage medium. In an alternative, the storage medium may be integral to the processor. The processor and the storage medium may reside in an application specific integrated circuit (“ASIC”). In an alternative, the processor and the storage medium may reside as discrete components. For example, FIG. 1 illustrates an example computer system 140 which may represent or be integrated in any of the above-described components, etc. FIG. 1 is not intended to suggest any limitation as to the scope of use or functionality of embodiments of the application described herein. The computer system 140 is capable of being implemented and/or performing any of the functionality set forth hereinabove.

The computer system 140 may be described in the general context of computer system-executable instructions, such as program modules, being executed by a computer system. Generally, program modules may include routines, programs, objects, components, logic, data structures, and so on that perform particular tasks or implement particular abstract data types. The computer system 140 may be embodied in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 140 is shown in the form of a general-purpose computing device. The components of the computer system 140 may include, but are not limited to, one or more processors (such as CPUs 142 and GPUs 144), a communication interface 146, one or more input/output interfaces 148 and the storage device 150. In some embodiments, the communication interface 146 may include a network interface, a network card, or the like, which is capable of wireless communications with a remote computer such as a cloud platform or a server. Although not shown, the computer system 140 may also include a system bus that couples various system components including system memory to the CPUs 142. In some embodiments, the input/output interfaces 148 may also include a network interface. For example, in some embodiments, some or all of the components of the control system 100 may be in communication via a controller area network (“CAN”) bus or the like.

The storage device 150 may include a variety of types and forms of computer readable media. Such media may be any available media that is accessible by computer system/server, and it may include both volatile and non-volatile media, removable and non-removable media. System memory, in one embodiment, implements the flow diagrams of the other figures. The system memory can include computer system readable media in the form of volatile memory, such as random-access memory (RAM) and/or cache memory. As another example, storage device 150 can read and write to a non-removable, non-volatile magnetic media (not shown and typically called a “hard drive”). Although not shown, the storage device 150 may include one or more removable non-volatile disk drives such as magnetic, tape or optical disk drives. In such instances, each can be connected to the bus by one or more data media interfaces. Storage device 150 may include at least one program product having a set (e.g., at least one) of program modules that are configured to carry out the functions of various embodiments of the application.

FIGS. 2A-2C are diagrams illustrating exterior views of a semi-truck 200 that may be used in accordance with example embodiments. Referring to FIGS. 2A-2C, the semi-truck 200 is shown for illustrative purposes only—those skilled in the art, upon reading the present disclosure, will appreciate that embodiments may be used in conjunction with a number of different types of vehicles. The example semi-truck 200 shown in FIGS. 2A-2C is one configured in a common North American style which has an engine 206 forward of a cab 202, a steering axle 214 and drive axles 216. A trailer (not shown) is attached to the semi-truck 200 via a fifth-wheel trailer coupling that is provided on a frame 218 positioned over the drive axles 216. A sleeper compartment 212 is positioned behind the cab 202. A number of sensors are positioned on different locations of the semi-truck 200. For example, sensors may be mounted on a roof of the cab 202 on a sensor rack 220. Sensors may also be mounted on side mirrors 210 as well as other locations. As will be discussed, sensors may be mounted on the bumper 204 as well as on the side of the cab 202 or other locations. For example, a rear facing radar 236 is shown as mounted on a side of the cab 202 in FIG. 2A. Embodiments may be used with other configurations of trucks or other vehicles (e.g., such as semi-trucks having a cab over or cab forward configuration or the like). In general, and without limiting embodiments of the present invention, features of the present invention may be used with desirable results in vehicles that carry cargo over long distances, such as long-haul semi-truck routes.

FIG. 2B is a front view of the semi-truck 200 and illustrates a number of sensors and sensor locations. The sensor rack 220 may secure and position several sensors including a long range lidar 222, long range cameras 224, GPS antennas 234, and mid-range front facing cameras 226. The side mirrors 210 may provide mounting locations for rear-facing cameras 228 and mid-range lidar 230. A front radar 232 may be mounted on the bumper 204. Other sensors may be mounted or installed on other locations—the locations and mounts depicted in FIGS. 2A-2C are for illustrative purposes only. Referring now to FIG. 2C, a partial view of the semi-truck 200 is shown which shows an interior of the cab 202 and the sleeper compartment 212. In some embodiments, portions of the control system 100 of FIG. 1 are deployed in a systems rack 240 in the sleeper compartment 212, allowing easy access to components of the control system 100 for maintenance and operation.

In the examples further described herein, the control system 100 in the example of FIG. 1 may be embodied within an ego vehicle such as the semi-truck 200 shown and described with respect to FIGS. 2A-2C. In these examples, the ego vehicle can use the sensors and other systems of the vehicle to detect the presence of another vehicle on a shoulder of a road while the ego vehicle is traveling along the road and approaching the ego vehicle. The ego vehicle may use a piecewise linear function to change speeds in short segments rather than using a constant change of speed. Furthermore, the ego vehicle may determine whether or not to perform a lane change (e.g., to a lane on an opposite side of the ego vehicle with respect to the shoulder). Whether such a lane change is made may be a dynamic decision made by the ego vehicle's computer as the ego vehicle is approaching the vehicle on the shoulder.

In the example embodiments, autonomous vehicles may upload driving data from a trip or a route which includes sensor data, log data, decisions made by the AV system, calculations made by the AV system, intermediate determinations, such as planner inputs, outputs, etc., and the like. Code developers may access the data and use it to test newly developed self-driving code such as a new code module or an update to an existing code module. The driving data may be stored in a distributed storage environment where it is made accessible at each of a plurality of different computers/endpoints with different/distributed geographical locations making the driving data more easily accessible.

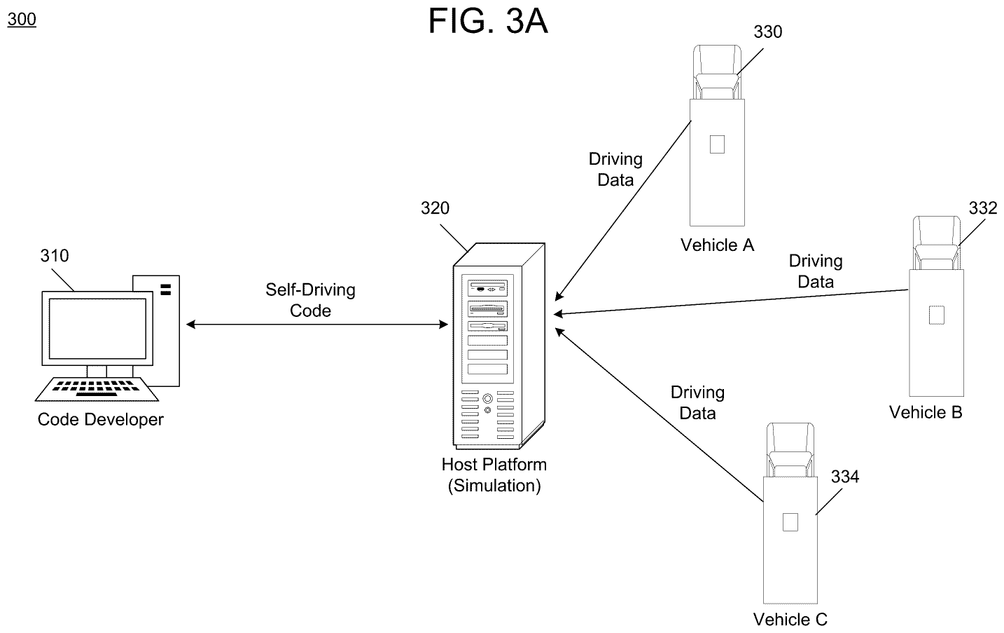

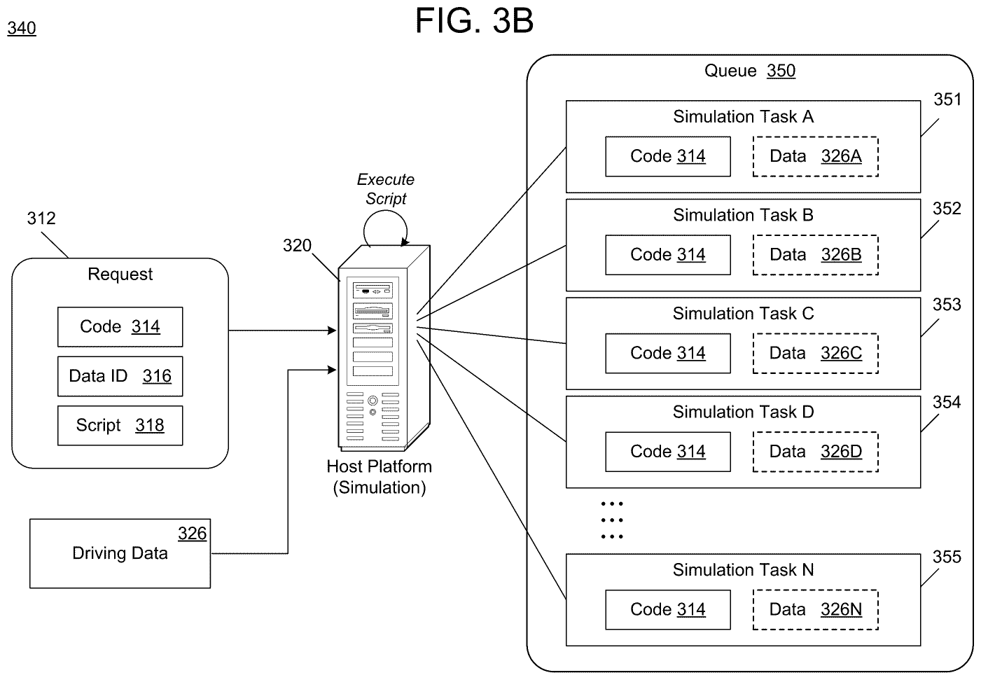

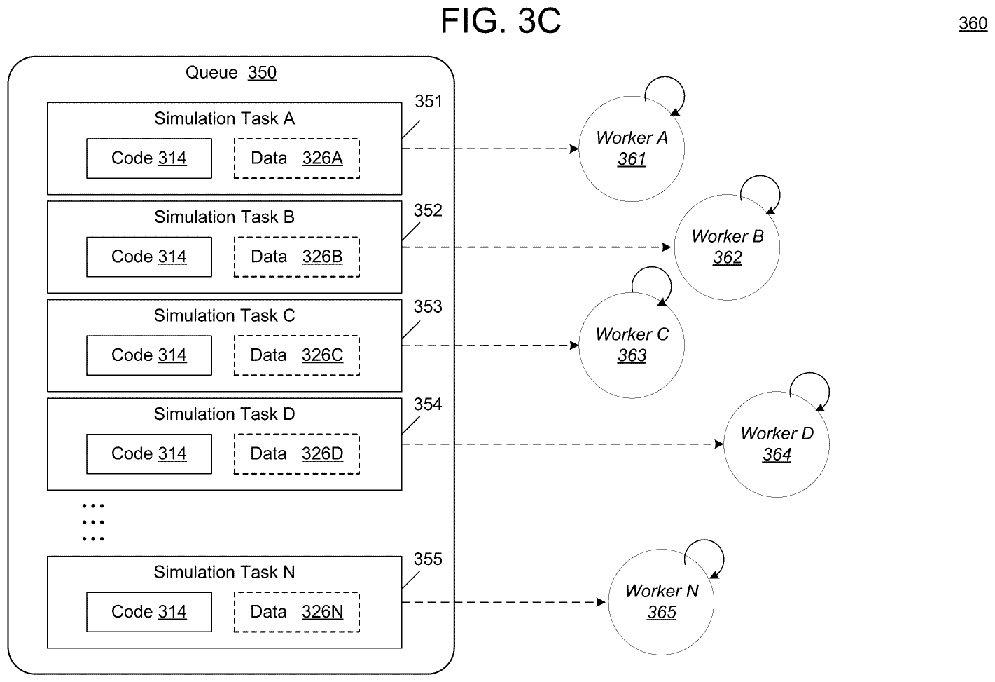

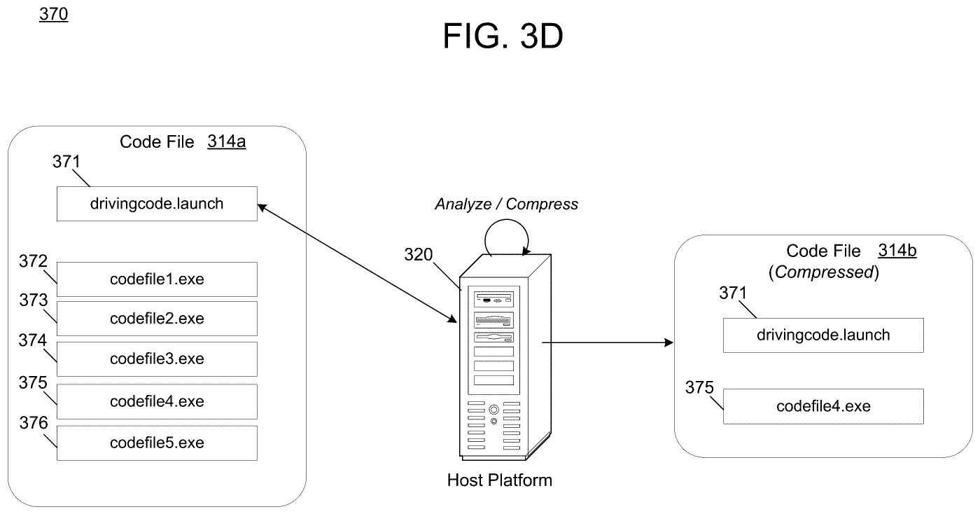

FIGS. 3A-3C illustrate a process of testing self-driving code in a distributed open-loop system in accordance with example embodiments. FIG. 3A illustrates an example of computing environment 300 in which the example embodiments may be performed. In this example, the simulation system for simulating autonomous driving code updates may be hosted by a host platform 320 such as a cloud platform, a web server, a blockchain network, and the like. In this examples, vehicles 330, 332, and 334 may register with the host platform 320 thereby identifying themselves (e.g., based on a vehicle ID of some kind) and begin uploading driving data to the host platform 320.

Driving data may include, but is not limited to, sensor data captured by a vehicle using any of the equipment or devices shown and described in FIGS. 1 and 2A-2C, any instructions created by a planning system of the vehicle, any intermediate calculations such as location, route guidance, etc., any issues encountered, and the like. This data may be stored by the host platform 320 based on a predefined structure. For example, the driving data may be organized by topic and stored with other driving data associated with the same topic. Topics may include categories or types of trucks, categories or types of training data, categories or types of self-driving code, and the like.

According to various embodiments, within the computing environment 300, code developers that develop the code (e.g., self-driving code, etc.) for the vehicles 330, 332, and 334 may use the driving data uploaded by the vehicles 330, 332, and 334, to test the code via a simulation application hosted by the host platform 320 (or possibly on another host system that is electrically connected to the host platform 320. For example, a user such as a code developer may use a user device 310 to submit a simulation request to the host platform. The driving data uploaded by the vehicles 330, 332, and 334 may be made available to the public or to permissioned users with registered access by the host platform 320. Furthermore, the host platform 320 may be a distributed platform such as a distributed cloud platform that provides different geographical access points to make the data even more accessible. The driving data may be captured by the vehicles 330, 332, 334, and then stored at the vehicles 330, 332, and 334, respectively, or transferred from the vehicles 330, 332, and 334, and stored elsewhere such as a server, a distributed storage platform, or the like. When the driving data is requested by a code developer, the driving data may be retrieved from the vehicles 330, 332, 334 themselves, or it may be retrieved from the storage elsewhere such as the server or distribute storage platform and delivered to the developer via a computer network.

FIG. 3B illustrates a process 340 of the host platform 320 processing a request 312 to test code 314 such as self-driving code that is configured to control movement and other aspects (e.g., direction, speed, acceleration, etc.) of an autonomous vehicle. Referring to FIG. 3B, the user (via the user device 310) or another system such as a software application or a service may access any desired driving data stored by the host platform 320. Here, the user device 310 may transmit a request that the host platform 320 simulate a new piece of code 314 such as self-driving software code that is to be added to a vehicle such as one of the vehicles 330, 332, or 334. Here, the request 312 may include the code 314 or an identifier of a location of the code 314 (e.g., network address, storage location, repository, etc.) which is accessible to the host platform 320. In addition, the request 312 may include an identifier of data 316, such as driving data, that is to be used to test the code 314.

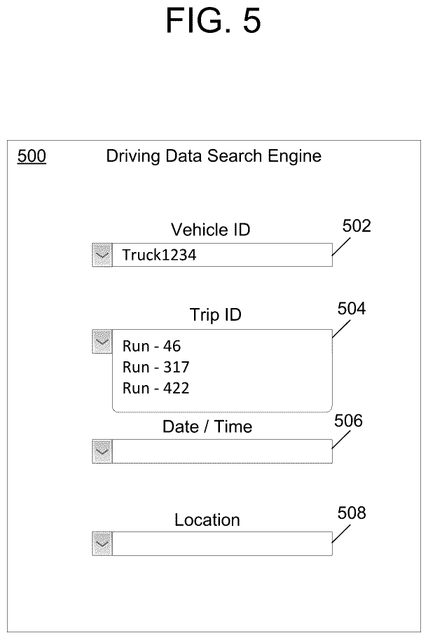

As an example, the request 312 may be sent from a user interface that enables a user to search for and select previous trips performed by any of the vehicles 330, 332, and 334, such as the user interface 500 shown in FIG. 5. In this example, fields 502, 504, 506, and 508 are shown and are associated with different search criteria for example, vehicle identifier, trip identifier (run ID), date, geographic location, or the like. In some cases, one or more of the search criteria may be used to refine the other search criteria. The fields 502, 504, 506, and 508 may include search bars, menus (drop-down, etc.) or the like.

As just one example, a user may select a particular vehicle using an input field such as field 502 (e.g., a drop-down box, a text content field, etc.) and input the name or other identifier of the vehicle. In response, the possible trips that are available in the trip ID input field 504 (such as another drop down box, radio button, or the like) may be refined to show only the trip IDs of that particular vehicle from among all the available vehicles on the system. Thus, a developer may choose the same vehicle where the self-driving code is to be uploaded. In this case, the developer may choose previous driving data of the same vehicle to thereby test the new self-driving code.

Referring again to FIG. 3B, in addition to specifying the code 314 and the data 316 to be tested, the request 312 may also include a script 318 that can be executed by the host platform 320. For example, the host platform 320 may use the script 318 (or some other software program) to execute a test simulation on the code 314 based on the driving data identified by the data 316. However, before simulating the code 314, the host platform 320 may divide or otherwise split-up the simulation into a plurality of simulation tasks 351, 352, 353, 354, and 355 that can be executed in parallel with one another. Here, the simulation tasks 351-355 are stored within a queue 350 controlled by the host platform 320.

According to various embodiments, each simulation task from among the plurality of simulation tasks 351-355 may test the self-driving code (code 314) using a different subset of the driving data. For example, the driving data may be sliced into predefined chunks or segments each having a predetermined amount (of driving time) of driving data. As an example, each chunk may include 10 seconds of driving data, but embodiments are not limited thereto. It should also be appreciated that the chunk size may be configured dynamically. For example, one software may be tested using 10 second intervals of data chunks and another software may be tested using 60 second intervals of data chunks.

As shown in FIG. 3B, each simulation task 351-355 is assigned a different data chunk from among data identified by a data ID of the data 316. In this example, the data ID maps to driving data 326 of a single run by a vehicle. The driving data 326 is divided into data chunks 326A, 326B, 326C, 326D, and 326N which may include a fraction or a portion of the driving data 326 but not all of the driving data 326. The amount of chunks and/or which task/workers are assigned to each chunk may be defined by the script 318. In this example, simulation task 351 is assigned data chunk 326A, simulation task 352 is assigned data chunk 326B, simulation task 353 is assigned data chunk 326C, simulation task 354 is assigned data chunk 326D, and simulation task 355 is assigned data chunk 326N.

FIG. 3C illustrates a process 360 of distributing the simulation tasks 351-355 across a plurality of workers 361, 362, 363, 364, and 365 and executing the simulation tasks 351-355 in parallel with one another on the host platform 320. As an example, each simulation task 351-355 may include an image (e.g., a containerized image) with a copy of the self-driving code (code 314) and the respective data from the driving data identified by the data ID of the data 316 to be executed by that task. Here, the host platform 320 may compile the code 314 and put it into the image as well as the respective subset of driving data and the script 318. The host platform may also spawn as many workers (processing threads, etc.) as desired, for example, as specified by the host platform 320 or as indicated by the script 318.

In the example of FIG. 3C, the host platform 320 spawns the same number of workers (workers 361-365) as there are simulation tasks 351-355 and deploys each simulation task to its own respective worker for simultaneous execution. The execution results may be stored in data store or otherwise output via a user interface so that the developer may see the results of the simulation. For example, the execution results may identify whether the code executed successfully, any errors or other issues, and the like. The data store may be a single system such as a server. As another example, the data store may be a distributed platform that includes a distributed network of computers, servers, databases, blockchain network, etc., in which multiple distributed computing systems share access to the data and are located at different geographical locations for easy access to the execution results.

In some embodiments, the host platform 320 may compress the code 314 that is used to execute the simulation tasks 351-355 via the plurality of workers 361-365. FIG. 3D illustrates a process 370 of compressing a code file 314a into a compressed code file 314b, in accordance with an example embodiment. The compression process may be performed prior to the simulation tasks 351-355 being distributed to the plurality of workers 361-365. For example, the host platform 320 that performs the distribution of the simulation tasks 351-355 may also compress the code prior to and/or during the distributing of the simulation tasks 351-355 to the plurality of workers 361-365.

Referring to FIG. 3D, the host platform 320 may use methodologies to minimize the size of the code file 314a that is being run and that is being sent to the workers. By compressing the code file prior to execution, the workers may have smaller execution tasks that can be performed quicker than if the file remains intact. Furthermore, each worker may be assigned the same compressed code thereby relieving the processing burden on each of the workers as there is less code to transfer/deploy.

In the example of FIG. 3D, the code file 314a includes a launch file 371, a plurality of executables 372, 373, 374, 375, and 376. The simulation task to be performed may be defined in a file such as the launch file 371 including identifications of functions, executables, data, and the like, to be executed. The launch file 371 may also be referred to as a file used to launch software processes such as executables 372, 373, 374, 375, and 376. Here, the host platform 320 may analyze the launch file 371 or any other file that is used to launch processes to identify which particular executables among the plurality of executables 372, 373, 374, 375, and 376 are to be part of the simulation task and remove those executables from the code file 314a. In the example of FIG. 3D, the host platform 320 determines that only executable file 375 is needed from among the plurality of executables 372, 373, 374, 375, and 376. Accordingly, the host platform 320 may delete or otherwise remove executables 372, 373, 374, and 376 from the code file 314a to generate a compressed code file 314b. The compressed code file 314b may be distributed to the plurality of workers 361-365 in FIG. 3C.

In this example, the binary code that the workers are going to run is compressed. The data itself is already compressed. Compressing the actual runtime executable that these workers are going to be using can save significant processing time. To perform this process, the host platform 320 may analyze software that the simulation task is going to run which may be defined in a launch file. Here, the host platform may inspect the launch file and determine the pieces of software to be built, the dependencies among the pieces of software, what codes needs to be built, and files to be included and accessed by the code at runtime. In the example of FIG. 3D, the code file is a project with five executables that may each require 10 files of 10 MBs to run. By removing some of the executables, less code needs to be built and less code needs to be transferred to the workers. The executables may be embodied in a hierarchy within the launch file. Each executable defines dependencies that need to be built to build it. The host platform 320 may use any of this data to create the compressed code file 314b.

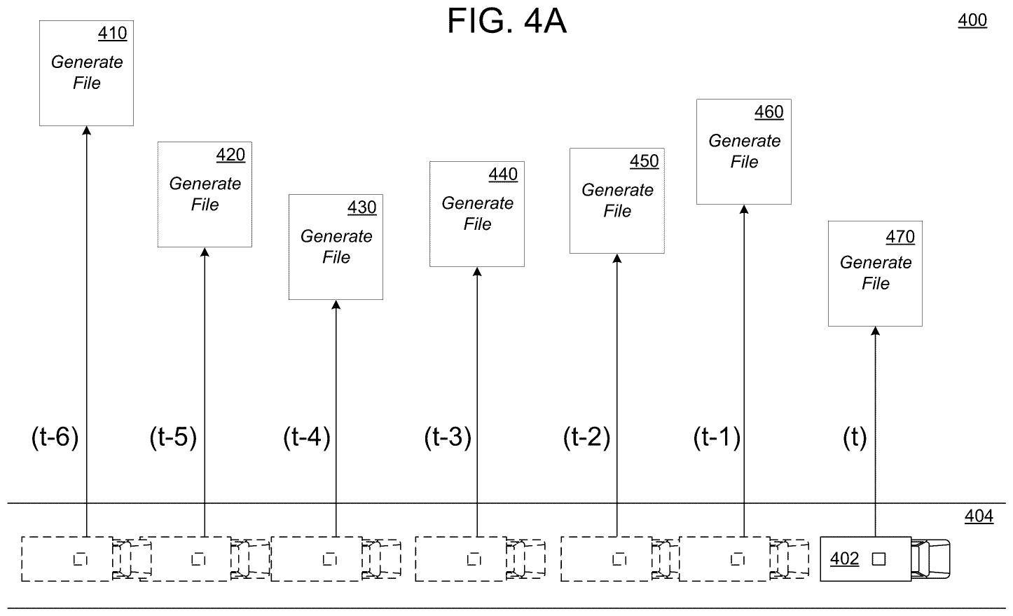

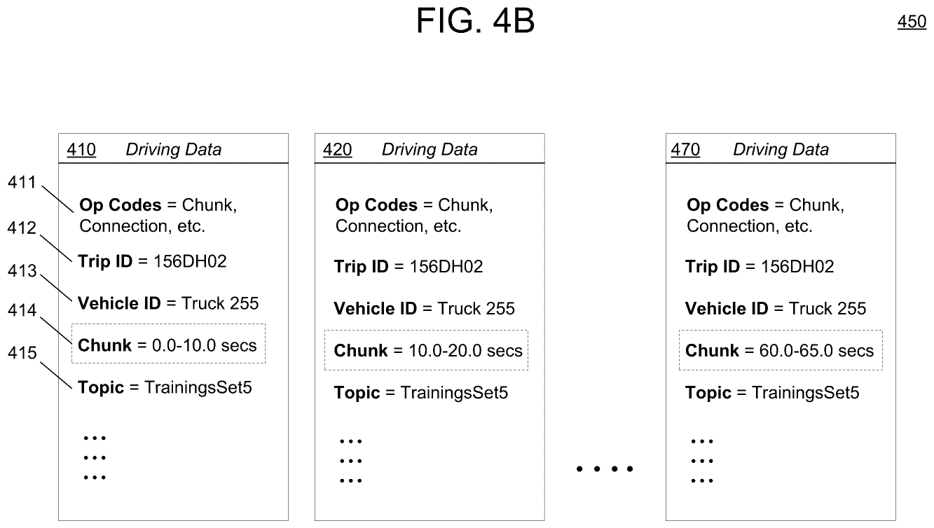

FIGS. 4A-4B illustrate examples of a process of creating files based on driving data in accordance with example embodiments. Referring to FIG. 4A, a process 400 of creating files 410, 420, 430, 440, 450, 460, and 470 of driving data is illustrated. In this example, a vehicle 402 is travelling along a road 404 and every predetermined interval (e.g., 10 seconds) the vehicle 402 is sending driving data to the host platform. The driving data may be captured in a file type referred to as ROS (robotic operating system) or ROS bags. Each “bag” may include a data chunk of a predetermined size, and information about the vehicle and/or the trip the vehicle is currently performing.

In this simple example, the vehicle 402 captures 65 seconds of driving data and stores the driving data as a trip on the host platform. Here, the chunk size is equal to 10 seconds. Thus, seven (7) files is needed to hold the 65 seconds of data with the seventh file only having five seconds of data. In this example, the most recently captured data (i.e., the seventh file 470) is actually a current time.

Referring to FIG. 4B, a more detailed example of the files 410-470 is shown. Each of the files 410-470 may be captured at sequential intervals that are mutually exclusive (not overlapping in time). As another example, some or all of the files 410-470 may partially overlap in time with other files or completely overlap in time. In the example of FIG. 4B, a file 410 includes one or more opcodes 411, a trip identifier 412, a vehicle identifier 413, a first subset of driving data 414 (e.g., the first 10 seconds of a trip, etc.), a topic 415, and the like. Meanwhile, a second file 420 may include a second subset of driving data (e.g., the next seconds of the trip, etc.) with respect to the first subset of driving data 414. Thus, each file in the sequence may include a subset of time from the trip that may be non-overlapping or mutually exclusive of the driving data in the other files.

The files 410-470 may include a header which identifies information about the file such as op codes which can be used to distinguish between different types of header and also identify the types of data within the file. For example, each file may include an identifier of the data chunk, connection data including a name of a topic where the data is to be stored, etc., message data, index data, chunk information, worker information, and the like. The driving data may initially be stored in files of the predetermined size (e.g., 10 seconds). Thus, the initial process of storing the data may prepare it for a subsequent request to simulate self-driving code using the data.

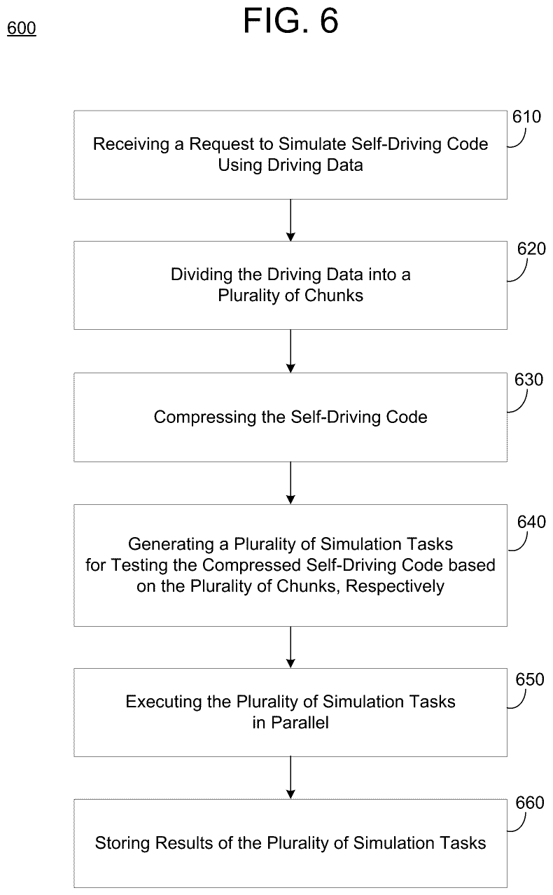

FIG. 6 illustrates a method 600 for testing self-driving code in accordance with an example embodiment. As an example, the method 600 may be performed by a processor, a computer, a chip, an apparatus, etc., that is embodied on a vehicle or a computer such as a cloud platform that is remotely connected to the vehicle. Referring to FIG. 6, in 610, the method may include receiving a request to simulate self-driving code against previously-captured driving data via a host platform. Here, the request may be from a developer of the self-driving code or another system or user. In some embodiments, the request may be input via a user interface.

In 620, the method may include dividing the driving data into a plurality of data chunks. In some embodiments, the dividing of the driving data may be performed in advance based on storage characteristics of the file protocol used by the host platform to the store the driving data. In 630, the method may include compressing the self-driving code to create compressed self-driving code. Here, the host may analyze attributes of the self-driving code such as the tasks and functions stored within a launch file of the self-driving code. In 640, the method may include generating a plurality of simulation tasks for testing the self-driving code based on the plurality of driving data chunks, respectively. In 650, the method may include executing the plurality of simulation tasks in parallel via a plurality of workers of the host platform, respectively. In 660, the method may include storing execution results of the plurality of simulation tasks via a memory.

In some embodiments, the receiving may include receiving the driving data over a computer network from a vehicle on a road, and storing the received driving data in a plurality of files corresponding to the plurality of data chunks. In some embodiments, the dividing may include breaking-up the driving data into equal-sized data chunks based on driving time of the driving data, and storing each equal-sized data chunk in a different file from among the plurality of files. In some embodiments, the method may further include executing a script which pulls the plurality of simulation tasks from a queue and assigns the plurality of simulation tasks to the plurality of workers based on predefined instructions within the script.

In some embodiments, the self-driving code comprises an update to a previously-created self-driving code previously stored on a vehicle, and the driving data is captured from a single run of the vehicle. In some embodiments, the method may further include spawning the plurality of workers, compiling the self-driving code into an executable file, and executing the executable file with the self-driving code on each of the plurality of workers.

In some embodiments, the executing may include assigning the mutually exclusive data chunks from the driving data to each worker from among the plurality of workers. In some embodiments, the driving data comprises sensor data captured and recorded by a vehicle, decisions made by an autonomous vehicle (AV) system of the vehicle, and planning data created by the AV system of the vehicle.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

1. An apparatus comprising:
a network interface configured to receive a request to execute a simulation of self-driving code against previously-captured driving data via a host platform; and
a processor configured to
slice the driving data into a plurality of data segments that comprise driving data from a plurality of mutually exclusive intervals of driving time, respectively, from among a total driving time of the driving data;
identify a software program to be tested within the self-driving code based on a file included within the self-driving code;
generate a plurality of simulation tasks for testing the self-driving code based on the plurality of data segments, wherein each simulation task includes the software program to be tested and a different data segment from among the plurality of data segments with driving data from a different mutually-exclusive interval of driving time, respectively;
execute the plurality of simulation tasks on the plurality of data segments in parallel, to test the software program on the driving data as a whole; and
store execution results of the plurality of simulation tasks via a data store.

2. The apparatus of claim 1, wherein the processor is configured to identify one or more executables that are to be executed during the simulation from a launch file used to launch software processes included in the self-driving code.

3. The apparatus of claim 1, wherein the processor is configured to receive the driving data over a computer network, and store the received driving data in a plurality of files corresponding to the plurality of mutually-exclusive intervals of driving time.

4. The apparatus of claim 3, wherein the processor is configured to break-up the driving data into a plurality of data chunks that each include a same amount of time of driving data.

5. The apparatus of claim 1, wherein the processor is configured to remove the plurality of simulation tasks from a queue and assign the plurality of simulation tasks to a plurality of workers based on predefined instructions within a script.

6. The apparatus of claim 1, wherein the self-driving code comprises an update to a previously-created self-driving code previously stored on a vehicle, and the driving data is captured from a previous run of the vehicle.

7. The apparatus of claim 1, wherein the processor is further configured to spawn a plurality of workers, compile the software program into a binary file, and execute the binary file on each of the plurality of workers.

8. The apparatus of claim 7, wherein the processor is configured to assign each data segment from among the plurality of data segments to a different worker from among the plurality of workers, respectively, such that each worker executes a different interval of driving time data.

9. The apparatus of claim 1, wherein the driving data comprises sensor data captured and recorded by a vehicle, decisions made by an autonomous vehicle (AV) system of the vehicle, and planning data created by the AV system of the vehicle.

10. A method comprising:
receiving a request to simulate self-driving code against previously-captured driving data via a host platform;
slicing the driving data into a plurality of data segments that comprise driving data from a plurality of mutually-exclusive intervals of driving time, respectively, from among a total driving time of the driving data;
identifying a software program to be tested within the self-driving code based on a file included within the self-driving code;
generating a plurality of simulation tasks for testing the self-driving code based on the plurality of data segments, wherein each simulation task includes the software program to be tested and a different data segment from among the plurality of data segments with driving data from a different mutually-exclusive interval of driving time, respectively;
executing the plurality of simulation tasks on the plurality of data segments in parallel to test the software program on the driving data as a whole; and
storing execution results of the plurality of simulation tasks via a data store.

11. The method of claim 10, wherein the identifying comprises identifying one or more executables that are to be executed during the simulation from a launch file used to launch software processes included in the self-driving code.

12. The method of claim 10, wherein the receiving comprises receiving the driving data over a computer network from a vehicle on a road, and storing the received driving data in a plurality of files corresponding to the plurality of mutually-exclusive intervals of driving time.

13. The method of claim 12, wherein the dividing comprises breaking-up the driving data into a plurality of data chunks that each include a same amount of time of driving data.

14. The method of claim 10, wherein the method further comprises removing the plurality of simulation tasks from a queue and assigning the plurality of simulation tasks to a plurality of workers based on predefined instructions within a script.

15. The method of claim 10, wherein the self-driving code comprises an update to a previously-created self-driving code previously stored on a vehicle, and the driving data is captured from a previous run of the vehicle.

16. The method of claim 10, wherein the method further comprises spawning a plurality of workers, compiling the software program into an executable file, and executing the executable file on each of the plurality of workers.

17. The method of claim 16, wherein the executing comprises assigning each data segment from among the plurality of data segments to a different worker from among the plurality of workers, respectively, such that each worker executes a different interval of driving time data.

18. The method of claim 10, wherein the driving data comprises sensor data captured and recorded by a vehicle, decisions made by an autonomous vehicle (AV) system of the vehicle, and planning data created by the AV system of the vehicle.

19. A non-transitory computer-readable medium comprising instructions which when executed by a processor cause a computer to perform a method comprising:
receiving a request to simulate self-driving code against previously-captured driving data via a host platform;
slicing the driving data into a plurality of data segments that comprise driving data from a plurality of mutually-exclusive intervals of driving time, respectively, from among a total driving time of the driving data;
identifying a software program to be tested within the self-driving code based on a file included within the self-driving code;
generating a plurality of simulation tasks for testing the compressed self-driving code based on the plurality of data segments, wherein each simulation task includes the software program to be tested and a different data segment from among the plurality of data segments with driving data from a different mutually-exclusive interval of driving time, respectively;
executing the plurality of simulation tasks on the plurality of data segments in parallel to test the software program on the driving data as a whole; and
storing execution results of the plurality of simulation tasks via a data store.

20. The non-transitory computer-readable medium of claim 19, wherein the slicing comprises slicing the driving data into a plurality of data chunks that each include a predefined amount of driving time from the driving data.
